(19) United States
(12) Patent Application Publication
(10) Pub. No.: US 2003/0077420 A1
(43) Pub. Date: Apr. 24, 2003

(54) Vacuum assisted thermolamination of three-dimensional inherently non-porous substrates and laminated articles therefrom

(76) Inventors: Jason C. Brodil, Midland, MI (US); Michael E. Hus, Midland, MI (US); Ellen M. Dubensky, Flushing, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/251,180

(22) Filed: Sep. 20, 2002

Related U.S. Application Data
(60) Provisional application No. 60/335,846, filed on Oct. 24, 2001.

(51) Int. Cl. B32B 1/00

(52) U.S. Cl. 428/141; 156/285

(57) ABSTRACT

Thermolaminate a thermally binding overlay onto an inherently non-porous substrate containing vacuum access means using a vacuum assisted process to prepare a thermolaminated inherently non-porous substrate.

### CROSS REFERENCE STATEMENT

This application claims the benefit of U.S. Provisional Application No. 60/335,846, filed Oct. 24, 2001.

### BACKGROUND OF THE INVENTION

1. Field of the Invention

The present invention relates to a general process for thermolaminating inherently non-porous substrates, particularly three-dimensional (3-D) inherently non-porous substrates, with a thermally binding overlay and laminated articles produced by that process.

2. Description of Related Art

Thermolamination is a means of imparting coatings, such as protective coatings and decorative coatings, onto substrates. Thermolamination is a common lamination process involving affixing a thermally binding overlay onto a substrate using a heat-activated adhesive. Thermally binding overlays are typically in the form of films or heat transfer foils. Films generally comprise a polymer sheet with a thermally activated adhesive on at least one surface. Heat transfer foils tend to be more complex in structure than films. A thermally binding overlay typically contains a carrier layer on one side and an adhesive layer on an opposing side with at least one functional layer laminated between the carrier layer and the adhesive layer. The carrier layer is removably affixed to a functional layer and is commonly removed after thermolamination. The adhesive layer of a thermally binding overlay contacts a surface of a substrate and affixes (thermolaminates) the thermally binding overlay to the substrate upon heating. Thermolamination often also includes applying pressure to hold a thermally binding overlay to a substrate while heating. Thermolamination is relatively common for coating flat surfaces such as papers, cards, and boards.

Thermolamination of 3-D surfaces is more challenging than thermolaminating a flat surface. A 3-D surface is non-planar, having a non-linear profile. 3-D surfaces have at least one surface recess (profile minimum), surface projection (profile maximum), or a combination of a surface recess and surface projection. Desirably, a thermally binding overlay conforms to a 3-D surface, preferably without trapping any air between the surface and the thermally binding overlay. Such trapped air can hinder contact between the thermally binding overlay and the surface.

Vacuum assisted thermolamination is helpful for thermolaminating to surfaces, particularly 3-D surfaces, of inherently porous substrates. An inherently porous substrate is sufficiently porous such that a vacuum applied to one surface of the substrate can draw a thermally binding overlay onto an opposing surface in the absence of molded or machined vacuum access means. Vacuum-assisted thermolamination involves: (a) bringing an adhesive layer of a thermally binding overlay into contact with a lamination surface; (b) removing air from between the thermally binding overlay and surface by means of a vacuum; and (c) heat activating the adhesive layer so as to adhere the thermally binding overlay to the lamination surface. Removing the air from between the thermally binding overlay and lamination surface allows increased contact between the adhesive layer and lamination surface, which typically results in better adhesion.

A substrate that is not inherently porous (a non-porous substrate), such as plastic and metal substrates, is not inherently suited for vacuum assisted thermolamination. Lamination of 3-D surfaces of plastic materials is often accomplished while injection molding the substrate. Lamination during injection molding involves positioning a thermally binding overlay inside of a mold with a release layer in contact with the mold and a transfer layer exposed to injected plastic. Injection molding a plastic substrate into the mold against the thermally binding overlay affixes the thermally binding overlay to the substrate. U.S. Pat. No. 4,994,224, for example, offers exemplary teachings on laminating during injection molding. Thermolaminating during injection molding, however, is limited primarily to plastic substrates.

A process for vacuum assisted thermolamination of any non-porous substrates, particularly for 3-D non-porous substrates, is desirable, especially if it is suitable for use with prefabricated substrates. Thermolaminating prefabricated substrates (“post-thermolaminating”) allows vendors to custom laminate substrates on demand, which in turn allows for rapid turn-around time for custom thermolamination orders. For example, a vendor may purchase a large volume of generic 3-D substrates (e.g., cellular phone cases or handheld electronic game cases) and then thermolaminate those parts with a desired design based on a consumer's request.

### BRIEF SUMMARY OF THE INVENTION

In a first aspect, the present invention is a thermolamination process comprising: (a) disposing a thermally binding overlay onto a lamination surface of an inherently non-porous substrate, wherein the substrate has effective vacuum access means defined therein and the thermally binding overlay has an adhesive on at least one surface that contacts the lamination surface; (b) drawing a vacuum through said vacuum access means in a manner sufficient to cause the said thermally binding overlay to at least partially conform to said lamination surface; and (c) heat activating said adhesive so as to affix said thermally binding overlay to said lamination surface.

In a second aspect, the present invention is an article comprising an inherently non-porous substrate having vacuum access means defined in said substrate and a thermally binding overlay affixed by means of a thermally activated adhesive to at least one surface of said substrate in a manner that covers said vacuum access means.

### DETAILED DESCRIPTION OF THE INVENTION

Inherently non-porous substrates are sufficiently gas impermeable so as to prevent a vacuum applied to one surface of the substrate to draw a thermally binding overlay to an opposing surface, in the absence of molded or machined vacuum access means defined in the substrate. Inherently non-porous substrates contain at least one inherently non-porous material. Inherently non-porous materials include those selected from a group consisting of polymers, such as polyethylene, polypropylene, polystyrene, polyamide, polyester, polyethylene terephthalate and engineering thermoplastics such as polycarbonate (PC), acrylonitrilebutadiene-styrene (ABS) copolymers, and PC/ABS blends; metals such as aluminum, magnesium, iron, steel, tin, copper, and bronze; and crystalline and amorphous inorganic materials such as rock, stone, ceramics, and glass. An inherently nonporous substrate may consist essentially of, or entirely of, at least one non-porous material. In this context, to “consist essentially of” means additional material introduces no discernable affect on the substrate's porosity. Inherently non-porous substrates may be compositions comprising materials in addition to inherently non-porous materials. For example, a porous wooden article with a polymeric film (e.g., film of latex paint) coating at least one surface can be an inherently non-porous substrate if the polymeric coating sufficiently reduces gas permeability through the substrate.

Inherently non-porous substrates of the present invention can be 3-D, meaning they can have a 3-D surface to which thermolamination occurs (lamination surface). Examples of substrates that have a 3-D surface include articles selected from a group consisting of raised panel doors, cellular phone housings, desktop telephone housings, handheld electronic device housings, and portable stereo housings.

Non-porous substrates of the present invention have effective vacuum access means defined in them. Vacuum access means facilitate removal of air from between a lamination surface and a thermally binding overlay. “Effective” vacuum access means allow sufficient evacuation of air between a lamination surface and a thermally binding overlay in contact with that lamination surface to cause the overlay to at least partially, preferably completely conform to the lamination surface.

Typically, vacuum access means are orifices that penetrate through a substrate from a lamination surface to an opposing surface (back surface). Such orifices allow a vacuum applied to a back surface of a substrate to remove gas from between the substrate's lamination surface and a thermally binding overlay in contact with the lamination surface. Vacuum access means can also be orifices that penetrate through a lamination surface and extend through a surface other than a back surface of the substrate.

Vacuum access means can also be in the form of a continuous pathway along a 3-D lamination surface through which air may travel. For example, a 3-D surface might contain a profile of ridges and valleys wherein the valleys extend to at a back surface or edge of the 3-D surface. Applying a vacuum along the ridges of the 3-D surface from the back surface or edge can effectively remove air from between the 3-D surface and a thermally binding overlay disposed on the 3-D surface. In such an example, the valleys are vacuum access means.

Vacuum access means can be machined features or inherent features of the substrate design and can be of any shape. Machined features include holes drilled through a substrate or grooves cut into a surface. Vacuum access means that are inherent features of a substrate are molded in the substrate when it is made. For example, slits that extend through a non-porous telephone housing (typically present over speakers and microphones) can act as vacuum access means. Preferably, a 3-D surface has at least one vacuum access means accessing each surface recess to facilitate conformation of a thermally binding overlay to each recess.

Thermally binding overlays have a thermally activated adhesive on at least one surface. The thermally activated adhesive can be a layer laminated to the overlay or a coating applied to the overlay. The adhesive contacts a lamination surface and, upon heat heating to a heat activation temperature, binds the overlay to the lamination surface. If a substrate has a glass transition temperature (T_{g}) or crystalline melt temperature (Tₘ), the adhesive desirably has a heat activation temperature below the substrate's T_{g} or Tₘ. The heat activation temperature of an adhesive is also desirably lower than any decomposition temperature for components in the thermally binding overlay and substrate. Examples of suitable thermally activated adhesives include ethylene vinyl acetate, acrylates, urethanes, and copolyester polyamides and blends thereof. A skilled artisan can identify a suitable adhesive for a specific substrate material without undue experimentation.

Thermally binding overlays for use in the present invention include both thermally binding films and heat transfer foils. Suitable thermally binding films include single layer and multilayer films (films with two or more layers). Thermally binding films generally comprise at least one polymer layer. Polymer layers can include virtually any polymer including acrylics, crosslinked acrylics, urethanes, polyesters, polyethylene (PE), polypropylene (PP), polyvinyl aromatics compounds such as polystyrene (PS), polyvinyl chloride, copolymers including PP/PE copolymers, ethylene/styrene interpolymers (ESI), and blends of various polymers. Films can comprise non-polymeric layers as well. For example, films can contain a layer of metal film such as aluminum foil, gold foil, or silver foil. Metal films layers can be uniform throughout the thermally binding film or comprise a pattern within the thermally binding film. Desirable patterns include decorative designs and functional patterns for use as electromagnetic shielding and antennae. Thermally binding films may also include additives such as pigments, IR active materials (e.g., carbon black and graphite), and electrically conductive fillers.

Suitable heat transfer foils for use in the present invention comprise an adhesive on one surface, a carrier layer on an opposing surface and at least one functional layer between the adhesive and the carrier layer. The carrier is removably affixed to an outer functional layer while the adhesive is on a first functional layer. In heat transfer foils containing only one functional layer, the first functional layer and outer functional layer are the same layer. When more than one functional layer is present, functional layers are laminated to adjacent layers. A generally suitable commercially available heat transfer foil is available under the trademark FLEXRITE™ (trademark of CFC International).

Each functional layer of a heat transfer foil imparts at least one property to a substrate upon thermolamination of the heat transfer foil to the substrate. For example, a functional layer can comprise an abrasion resistant material, forming an abrasion resistant layer on a substrate upon thermolamination. Abrasion resistant layers are preferably an outer functional layer and protect a substrate, adhesive layer, and any other functional layers from abrasion. A suitable heat transfer foil for use in the present invention can consist essentially of an adhesive layer, an abrasion resistant layer, and a carrier layer. Suitable abrasion resistant materials typically comprise acrylics, urethanes, or polyester films. Preferably, an abrasion resistant layer is a cured (crosslinked) acrylic.

Another useful functional layer is a pigment layer. A pigment layer can, for example, comprise a polymer film impregnated with a pigment or simply a pigment disposed on an adjacent layer, such as an abrasion resistant layer. Pigments may be uniform, imparting a uniform color to a substrate surface, or patterned, imparting color to only a portion of a substrate surface. Multiple pigment layers may be present to form an intricate and multicolored patterns including company logos, photograph images, simulated wood grain and artistic designs.

Still another useful functional layer is a conductive material such as silver paint, aluminum foil, or other metal foil, or carbon pigments. A functional layer comprising a conductive material can serve multiple purposes including forming aesthetically pleasing designs, acting as an antenna for electronic equipment, and acting as an electromagnetic interference (EMI) shield for electronic items such as cellular phones. The conductive material may be a uniform functional layer or it may be a specific pattern. A pattern can be a functional pattern (i.e., a pattern that serves a purpose other than aesthetics) such as can be beneficial for an antenna.

Preferably, the outer functional layer of a heat transfer foil is a release layer. Release layers provide a surface for binding a carrier layer in such a manner that the carrier layer is removable without damaging the rest of the thermally binding overlay. Typical release layers comprise silicone materials or fluoropolymers.

Carrier layers provide a durable medium for supporting layers of a heat transfer foil prior to lamination. Carrier layers can comprise, for example, a polyvinyl chloride (PVC) polymer or an interpolymer such as an ethylene/styrene interpolymer. A carrier layer removably affixes to an outer functional layer of a heat transfer foil. A carrier layer that is “removably affixed” to an outer functional layer can be removed from the outer functional layer without damaging the outer functional layer. Typically, a carrier layer is peelable off from an outer functional layer.

Desirably, thermally binding overlays for use with 3-D substrates are sufficiently flexible to conform to a 3-D surface contour of the 3-D substrate. Preferably, though not necessarily, thermally binding overlays are sufficiently flexible to conform to a 3-D surface at a temperature below the activation temperature of the thermally binding overlay's adhesive layer.

The process of the present invention includes disposing a thermally binding overlay onto a lamination surface of an inherently non-porous substrate having vacuum access means defined therein and drawing a vacuum through the vacuum access means in a manner sufficient to cause the thermally binding overlay to at least partially, preferably completely conform to the lamination surface. Desirably, the vacuum removes most of any air between the thermally binding overlay and lamination surface. Preferably, the vacuum removes sufficient air from between the transfer foil and the lamination surface to allow the thermally binding overlay to contact the entire lamination surface.

Generally, a substrate sits on a table, preferably on a fixture set on a table during lamination. A fixture holds a substrate from moving during lamination and can provide support to prevent substrate deformation during lamination. A thermally binding overlay lies over the substrate. Applying a vacuum through the table, fixture, substrate, or any combination thereof draws the thermally binding overlay against the substrate's lamination surface. Desirably, a seal forms between the thermally binding overlay (a) the edges of the substrate, (b) a table on which the substrate sits, (c) a fixture holding the substrate, or any combination of (a), (b), and (c) to facilitate removal of air from between the overlay and lamination surface. Herein, “seal” refers to contact that restricts airflow. The process allows for lamination of a single substrate or simultaneous lamination of multiple substrates.

The process of the present invention advantageously includes pressing a thermally binding overlay against a lamination surface of a substrate, preferably while drawing a vacuum through vacuum access means in the substrate. Pressing the overlay against the lamination surface can help to seal the thermally binding overlay against the substrate, as well as help to conform the overlay to the lamination surface. Forced air, preferably heated air, is a suitable means of applying pressure. Alternatively, materials such as rigid (e.g., metal plate) or flexible (e.g., rubber membrane) structures may press against a thermally binding overlay to apply pressure. Preferably, heat the structure to facilitate flexibility of the thermally binding overlay and to activate adhesion of the thermally binding overlay to the lamination surface. When using a 3-D lamination surface and a rigid structure to apply pressure, the structure preferably contains 3-D imprints in the shape of the 3-D lamination surface aligned such that each substrate fits into an imprint while applying pressure.

One particularly useful process of the present invention uses a membrane press to laminate a thermally binding overlay to an inherently non-porous substrate. A membrane press comprises a press table, a heated rubber membrane, and a vacuum pump. To use a membrane press, place a substrate, or more than one substrate, on a press table. Position a thermally binding overlay between the rubber membrane of the membrane press and the substrate(s) such that an adhesive layer of the thermally binding overlay is proximate to the substrate(s). Heat the rubber membrane, press the thermally binding overlay against the substrate(s) using the rubber membrane, and draw a vacuum through the press table and through vacuum access means in the substrate(s). Heat the thermally binding overlay sufficiently to activate the adhesive layer. Release the pressure of the membrane and the vacuum to retrieve the laminated substrate(s). A membrane press is particularly well suited for laminating a thermally binding overlay to 3-D non-porous substrate(s).

The following example serves to further illustrate the present invention and does not limit the scope in any way.

### EXAMPLE (EX) 1

### Heat Transfer Foil Decoration of a PC/ABS Simulated Cellular Phone Faceplate

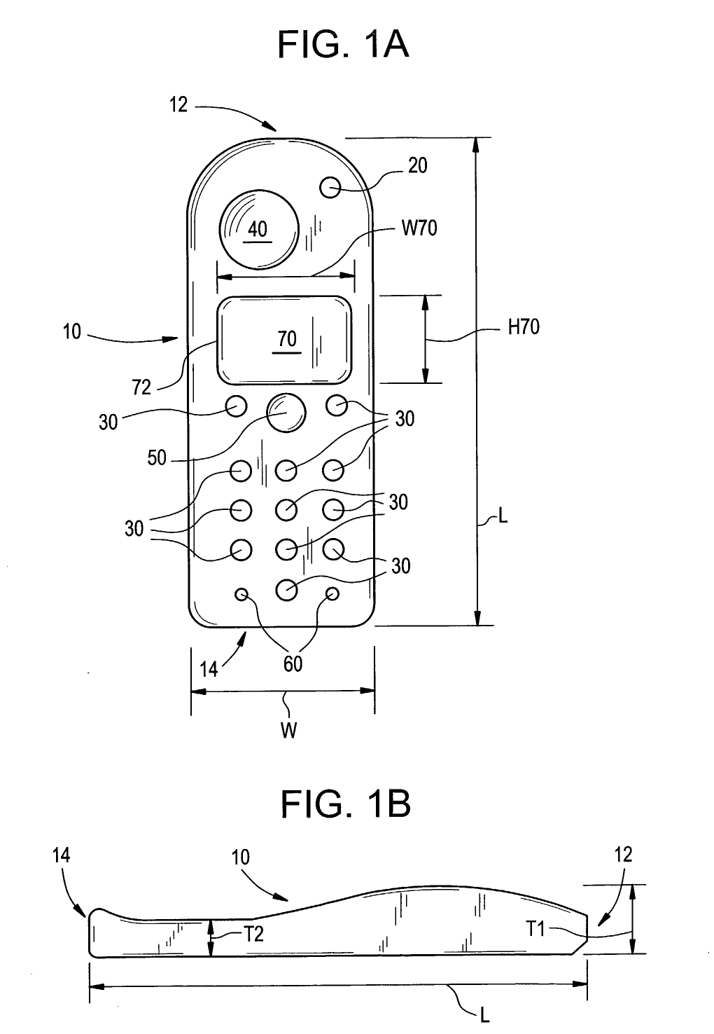

Prepare a cellular phone faceplate by thermomolding a sheet of PC/ABS (EMERGE 7100 resin from The Dow Chemical Company) that is 0.5 mm thick over to a mold using any standard thermomolding process. The mold is a polyester material (BONDO® filler, BONDO is a trademark of Dynatron/Bondo Corporation) molded in the shape of a cellular phone (see, FIGS. 1a and 1b). The ABS sheet conforms to the features of the mold.

FIGS. 1a and 1b illustrate the mold (10) from a front-view and side view, respectively. Length L of mold 10 is 13 centimeters (cm) and extends from top 12 to bottom 14. Width W (only FIG. 1a shows W) is 4.7 cm. At its thickest, T1, mold 10 is 2 cm thick. At its thinnest, T2, mold 10 is 1.4 cm thick. (only FIG. 1b shows T1 and T2). Mold 10 has multiple recessed features. Features 20, 30, 40, 50, and 60 are semispherical dimples (recesses). Features 20 and 30 that are 7 millimeters (mm) in diameter. Feature 40 is 22 mm in diameter. Feature 50 is 12 mm in diameter. Features 60 are 4 mm in diameter. Features 20, 30, 40, and 50 are approximately 2 mm deep while features 60 are approximately 1 mm deep. Feature 70 is rectangular having sides 72 that curve 2 mm towards the center of the feature as they depress in to mold 10. Feature 70 has a width, W70, of 3.2 cm and a height, H70, of 2.2 cm at the surface of mold 10. Feature 70 is approximately 1 (one) mm deep.

While the PC/ABS sheet is still on the mold, drill 1/16^{th}-inch (1.6 millimeter) holes through the center of each feature and in each corner of feature 70. Each hole penetrates through the PC/ABS sheet and the mold and will act as a vacuum access means. Trim the PC/ABS sheet uniformly 7 mm from the bottom of the mold to form a simulated cellular phone faceplate. Bevel the exposed 7 mm of the mold so to narrow dimensions of the back (face remote from the PC/ABS sheet) by approximately 4 mm.

Position the molded PC/ABS sheet, still on the mold, onto a table of Shaw-Almex Thermolaminator (model TL3-4) membrane press. Position a heat transfer foil (FLEXRITE 3218 AC-50) over the PC/ABS simulated cellular phone faceplate such that the transfer foil has a carrier sheet remote from the PC/ABS simulated cellular phone faceplate. Optimal results occur when the transfer foil spans the entire table of the membrane press.

Thermolaminate the transfer foil to the PC/ABS simulated cellular phone faceplate by activating the membrane press. Membrane press parameters are as follows: Membrane Temperature (152° C.), Bottom Temperature (38° C.), Pressing Pressure (200 megapascal (MPa)), 0 second pre-heat, 0 second vinyl inflate, 10 second pre-vacuum, 60 second press time, 2 second membrane release, 10 second vinyl cooling. A cellular phone faceplate made of inherently non-porous material that is thermally laminated using a vacuum assisted thermolamination process (Ex 1) results.

Peal away the carrier layer with any non-laminated transfer foil layers to retrieve Ex 1 containing a portion of the transfer foil (in this case, all but the carrier layer).

The PC/ABS simulated cellular phone faceplate has a smoothly laminated surface. The transfer foil fully conforms to features 40 and 50. The transfer foil partially conforms to features 20, 30, and 60, with a slight air gap between the transfer foil and substrate at the bottom of the features. Expect that increasing the membrane temperature will enhance lamination into features 20, 30, and 60.

Ex 1 illustrates a vacuum assisted thermolaminated inherently non-porous substrate having a 3-D surface comprising a variety of recesses of different sizes and shapes.

Ex 1 utilizes a transfer foil that has a PVC carrier layer. Expect similar results with transfer foils containing an ESI carrier layer.

What is claimed is:

1. A thermolamination process comprising:
(a) disposing a thermally binding overlay onto a lamination surface of an inherently non-porous substrate, wherein the substrate has effective vacuum access means defined therein and the thermally binding overlay has an adhesive on at least one surface that contacts the lamination surface;
(b) drawing a vacuum through said vacuum access means in a manner sufficient to cause the said thermally binding overlay to at least partially conform to said lamination surface; and
(c) heat activating said adhesive so as to affix said thermally binding overlay to said lamination surface.

2. The process of claim 1, further comprising pressing said thermally binding overlay against said substrate during (b).

3. The process of claim 1, wherein (a), (b), and (c) occur in a membrane press.

4. The process of claim 1, wherein said lamination surface is a three-dimensional lamination surface.

5. The process of claim 4, wherein said 3-D lamination surface contains recesses, wherein each recess has at least one vacuum access means in contact therewith.

6. The process of claim 1, wherein said inherently non-porous substrate contains a polymeric material comprising a polymer selected from a group consisting of polyethylene, polypropylene, polystyrene, polyamide, polycarbonate, polyester, polyethylene terephthalate, acrylonitrile-butadiene-styrene copolymers, and polycarbonate/acrylonitrile-butadiene-styrene copolymer blends.

7. The process of claim 1, wherein said inherently non-porous substrate contains an inherently non-porous material selected from metals, amorphous inorganic materials, and crystalline inorganic materials.

8. The process of claim 1, wherein said inherently non-porous substrate is an article selected from a group consisting of raised panel doors, cellular phone housings, desktop telephone housings, handheld electronic device housings, and portable stereo housings.

9. The process of claim 1, wherein said thermally activated adhesive is selected from a group consisting of ethylene vinyl acetate, acrylates, urethanes, and copolyester polyamides.

10. The process of claim 1, wherein the thermally binding overlay includes at least one functional layer that is electrically conductive.

11. The process of claim 1, wherein the thermally binding overlay includes at least one layer that contains a pigment.

12. The process of claim 1, wherein the thermally binding overlay includes a carrier layer and the process further comprising removing said carrier layer from said thermally binding overlay after affixing said thermally binding overlay to said substrate.

13. An article comprising inherently non-porous substrate having vacuum access means defined in said substrate and a thermally binding overlay affixed by means of a thermally activated adhesive to at least one surface of said substrate in a manner that covers said vacuum access means.

14. The article of claim 12, wherein said surface is three-dimensional.

15. The article of claim 12, wherein said thermally binding overlay is at least a portion of a heat transfer foil.

16. The article of claim 12, wherein said substrate contains a polymer selected from a group consisting of polyethylene, polypropylene, polystyrene, polyamide, polycarbonate, polyester, polyethylene terephthalate, acrylonitrile-butadiene-styrene copolymers, and blends thereof.

17. The article of claim 12, wherein said substrate contains a material selected from metals, crystalline inorganic materials, and amorphous inorganic materials.

18. The article of claim 12, wherein said substrate is selected from a group consisting of raised panel doors, cellular phone housings, desktop telephone housings, handheld electronic device housings, and portable stereo housings.
